(19) United States
(12) Patent Application Publication
(10) Pub. No.: US 2018/0277945 A1
(43) Pub. Date: Sep. 27, 2018

(54) REVERSE-FEEDING ANTENNA

(71) Applicant: ANTERFA INTERNATIONAL CO., LTD., Hsinchu City (TW)

(72) Inventor: Orry LAI, Hsinchu City (TW)

(73) Assignee: ANTERFA INTERNATIONAL CO., LTD., Hsinchu City (TW)

(21) Appl. No.: 15/661,775

(22) Filed: Jul. 27, 2017

(30) Foreign Application Priority Data
Mar. 27, 2017 (TW) 106204276

(51) Int. Cl. H01Q 1/48

(52) U.S. Cl. CPC H01Q 1/48; H01Q 1/22

(57) ABSTRACT

A reverse-feeding antenna includes an antenna body, a coaxial cable and a grounding conductor. The antenna body is an electrically conductive element, and the coaxial cable is formed of an electrically conductive material, and includes an external conductor and an internal conductor. The internal conductor of the coaxial cable extends and electrically connects the antenna body and the grounding conductor at a first connection point as an antenna feeding point. The external conductor of the coaxial cable electrically connects the antenna body at a second connection point. The grounding conductor is configured and electrically connected to both of the antenna body and the surrounding conductor to form a ground part for the antenna body. Therefore, the present invention greatly reduces voltage standing wave ratio (VSWR) and further improves efficiency of antenna radiation.

### CROSS-REFERENCE TO RELATED APPLICATION

This application claims the priority of Taiwanese patent application No. 106204276, filed on Mar. 27, 2017, which is incorporated herewith by reference.

### BACKGROUND OF THE INVENTION

### 1. Field of the Invention

The present invention is related to a reverse-feeding antenna (RFA). The RFA consists of an antenna body electrically connected to a coaxial cable that inner conductor of coaxial cable is electrically connected to the feeding point of antenna with directly conducting path to surrounding conductor (or chassis ground); outer conductor of coaxial cable is also electrically connecting to antenna but without directly conducting path to ground. In traditionally/typically compact antenna design for mobile device, e.g. PIFA, directly conducting path to ground is formed by outer conductor of coaxial cable and antenna element instead of inner conductor of coaxial cable and antenna. In this present invention, reverse-feeding mechanism is invented by connecting the feeding point which formed by antenna body and inner conductor of coaxial cable to ground with directly conducting path. With the reversed feeding of antenna, surrounding conductor of antenna can be connected and put into account on impedance calculation hence impedance matching and radiation efficiency of antenna can be improved in a conductor-surrounding environment.

### 2. The Prior Arts

The typically/traditionally compact antenna designed for wireless communication devices is illustrated in FIG. 6. It shows one antenna comprising an antenna body 10, a coaxial cable 20, and a grounding conductor 40. Furthermore, the coaxial cable 20 has an inner conductor 21 and an outer conductor 22, wherein the outer conductor 22 is electrically and directly connected to the grounding conductor 40, the inner conductor 21 is only connected to the antenna body 10.

Moreover, the antenna in the prior arts is connected to the ground level of the wireless communication device/system by directly connecting the outer conductor of coaxial cable and grounding conductor.

For the antenna structure revealed in prior arts, the impedance matching/VSWR and bandwidth are poor in the environment surrounded by metal or conductor. As a result, efficiency of antenna radiation will perform worse.

Therefore, new feeding mechanism of antenna provides better impedance matching/VSWR for which is applied in metal-surrounding environment to overcome the above-mentioned problems is essential and valuable. The reverse-feeding antenna employs the antenna's feeding point with inner conductor of coaxial cable to electrically connect to the surrounding conductor, i.e. ground; such a result, additional reactance from surrounding conductor would be appeared in the equivalent circuit of antenna and could effectively modify the antenna impedance. As compared with traditionally feeding mechanism, reverse-feeding structure will treat the surrounding conductor as a part of antenna; however, in traditional case, surrounding conductor is treated as a normal ground without benefits for impedance matching and radiation efficiency. In reverse-feeding antenna, surrounding metal of antenna will be put into account on impedance matching; therefore, VSWR and radiation efficiency could be greatly improved in a worse environment for antenna.

### SUMMARY OF THE INVENTION

The primary objective of the present invention is to provide a reverse-feeding structure to improve antenna's impedance matching, bandwidth and radiation efficiency. As illustrated in FIG. 1, the reverse-feeding antenna of the present invention comprises an antenna body, a coaxial cable, and a grounding conductor. The antenna body is an electrically conductive element. The inner conductor of coaxial cable is electrically connected to both of antenna body and the grounding conductor at a first connection point as antenna's feeding point. The outer conductor of coaxial cable is electrically connected to another point of antenna body at a second connection point so as to provide the return path of antenna current to generator. The surrounding conductor of antenna is configured and electrically connected to the antenna's feeding point with the connection of grounding conductor to be as a portion of antenna. As compared with typical antenna feeding, the present invention provides a “reversed” feeding structure and adopts the equivalently series reactance from the surrounding conductor for antenna impedance.

Furthermore, the electrical connection between the grounding conductor and the antenna feeding point can be implemented by a reactance element as shown in FIG. 2, which may comprise at least one capacitor, inductor or metal wire and serves as a matched network. The reactance element is further tuned and optimized to achieve best impedance matching for the antenna, thereby increasing the flexibility of impedance matching.

The reverse-feeding antenna of the present invention is preferably installed onto a metallic structure as shown in FIG. 3, which comprises at least one of a system metal plate, an LCD (liquid crystal display) panel, and an electrical circuit board stacked together.

According to the reverse-feeding structure of the present invention, the inner conductor of coaxial cable is electrically connected to both of antenna body and surrounding conductor; hence the media and the conductor potentially affecting antenna impedance are taken as a part of antenna. Such a result, the series reactance contributed by the environment is added into antenna's equivalent circuit and can be matched/compensated by tuning antenna's impedance. Therefore, VSWR and radiation efficiency can be great improved in a poor condition of antenna surrounded by conductor.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an illustration of the reverse-feeding antenna according to one embodiment of the present invention;

FIG. 2 is an illustration of one exemplary example of the reverse-feeding antenna according to the present invention connected to a reactance element in series;

FIG. 3 illustrates one application of the reverse-feeding antenna installed in a system with surrounding conductors which are including metallic enclosure, LCD panel and electrical circuit board according to the present invention;

FIG. 4 shows the performance of VSWR vs. frequency for the reverse-feeding antenna of the present invention;

FIG. 5 shows the performance of radiation efficiency vs. frequency for the reverse-feeding antenna of the present invention; and

FIG. 6 illustrates the typical feeding structure in the prior arts.

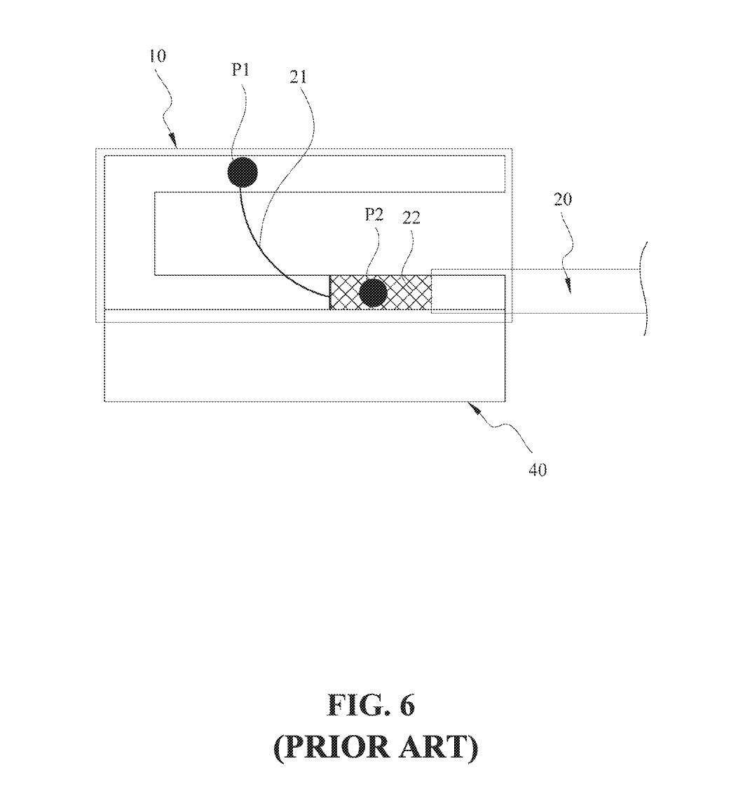

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

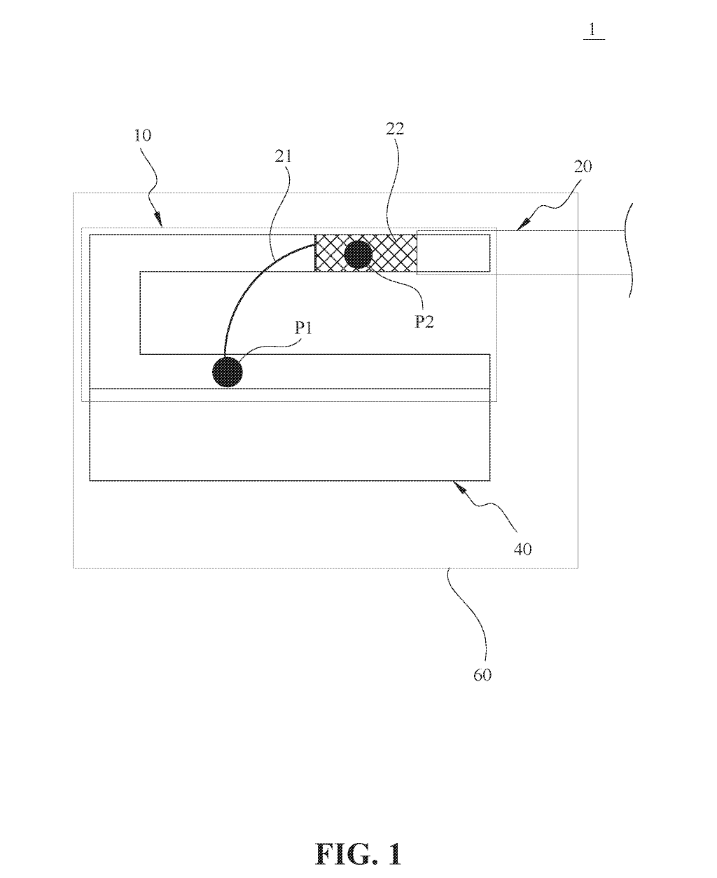

Please refer to FIG. 1 showing the reverse-feeding antenna according to one embodiment of the present invention. As shown in FIG. 1, the reverse-feeding antenna 1 generally comprises an antenna body 10, a coaxial cable 20, and a grounding conductor 40. The antenna body 10 is a conductive element, and the coaxial cable 20 is formed of an electrically conductive material, and comprises an inner conductor 21 and an outer conductor 22. Specifically, the inner conductor 21 of the coaxial cable 20 electrically connects between the antenna body 10 and the grounding conductor 40 at a first connection point P1 as an antenna feeding point. Further, the outer conductor 22 of the coaxial cable 20 electrically connects the antenna body 10 at a second connection point P2. The grounding conductor 40 is electrically connected between both of the antenna body 10 and the surrounding conductor 60 to form a ground part for the antenna body 10.

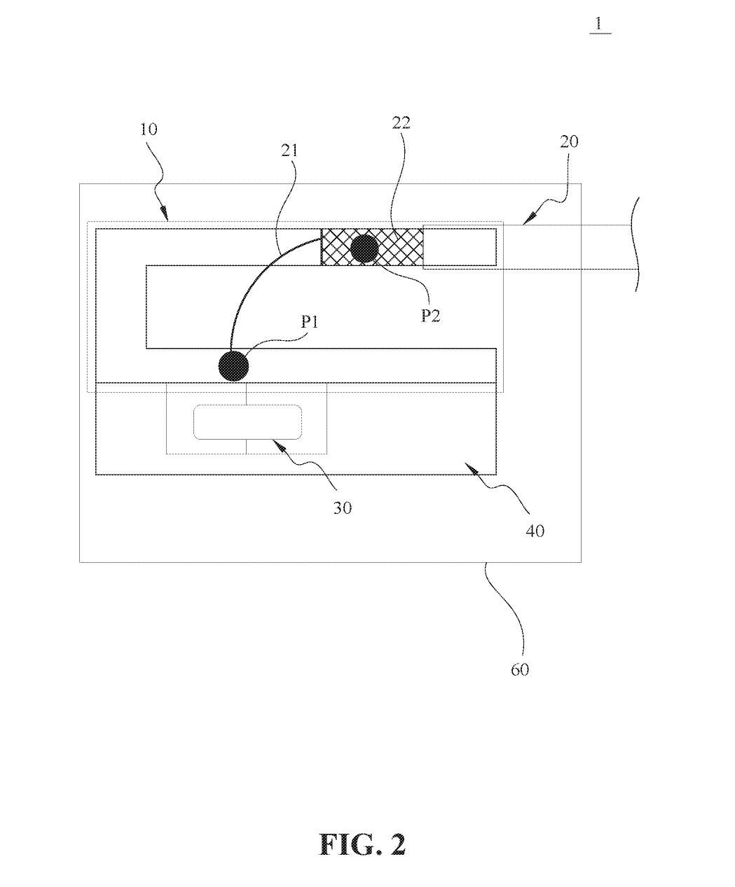

Further refer to FIG. 2 illustrating one exemplary example of the reverse-feeding antenna of the present invention, which is connected to a reactance element 30 in series between grounding conductor and surrounding conductor 60. For example, the reactance element 30 may comprise at least one capacitor, inductor or metal wire to form a matched network. The reactance element 30 can be further tuned and optimized to achieve best impedance match for the antenna, thereby increasing flexibility for impedance matching.

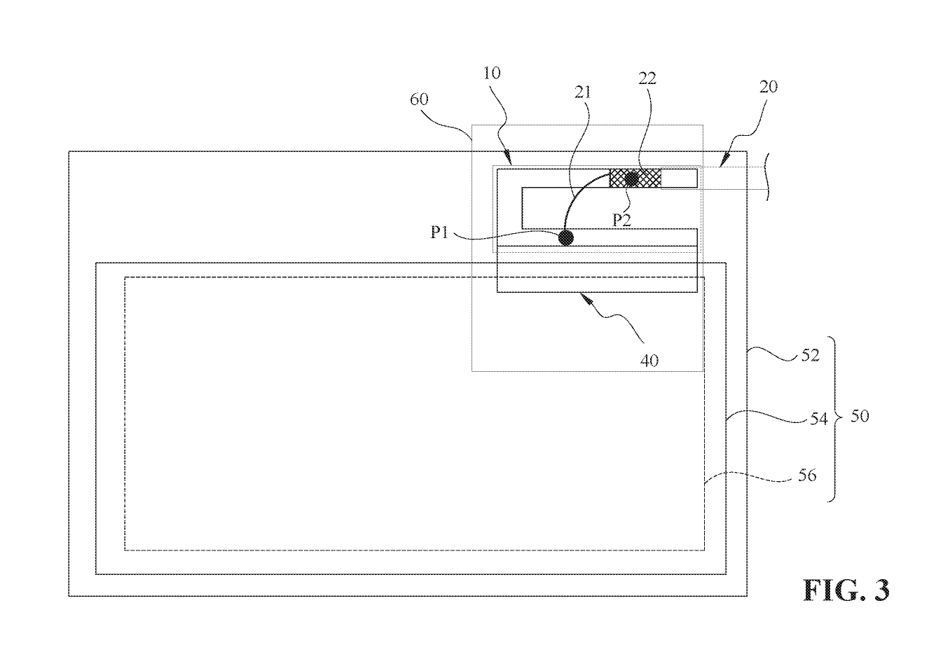

Then, one application of the reverse-feeding antenna according to the present invention is shown in FIG. 3. The reverse-feeding antenna of the present invention is exemplarily installed onto a metallic structure 50, which comprises at least one of a metallic enclosure 52, an LCD panel 54, and an electrical circuit board 56. The ground of the electrical circuit board 56 is connected to the metallic enclosure 52 and the LCD panel 54. More specifically, for the reverse-feeding antenna installed onto the metallic structure 50, the grounding conductor 40 is electrically connected to the metallic enclosure 52, the LCD panel 54, and the electrical circuit board 56.

As described, one primary feature of the present invention is that the inner conductor 21 of the coaxial cable 20 is electrically connected to both of the antenna body 10 and the grounding conductor 40 at the first connection point P1 as the antenna feeding point then connected to surrounding conductor 60 thru grounding conductor 40 such that the media and the metal potentially affecting antenna impedance are put into account on antenna's impedance matching so as to improve bandwidth and radiation efficiency.

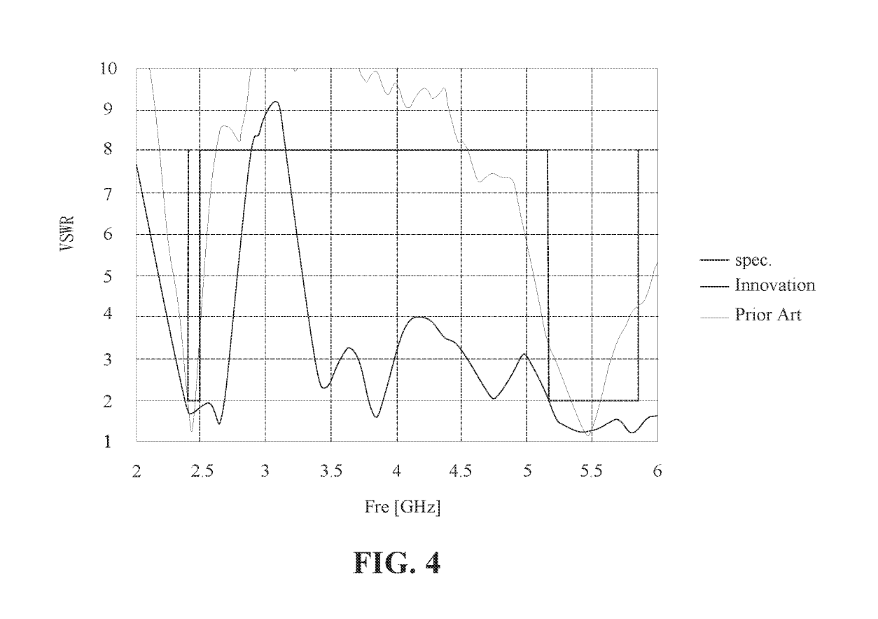

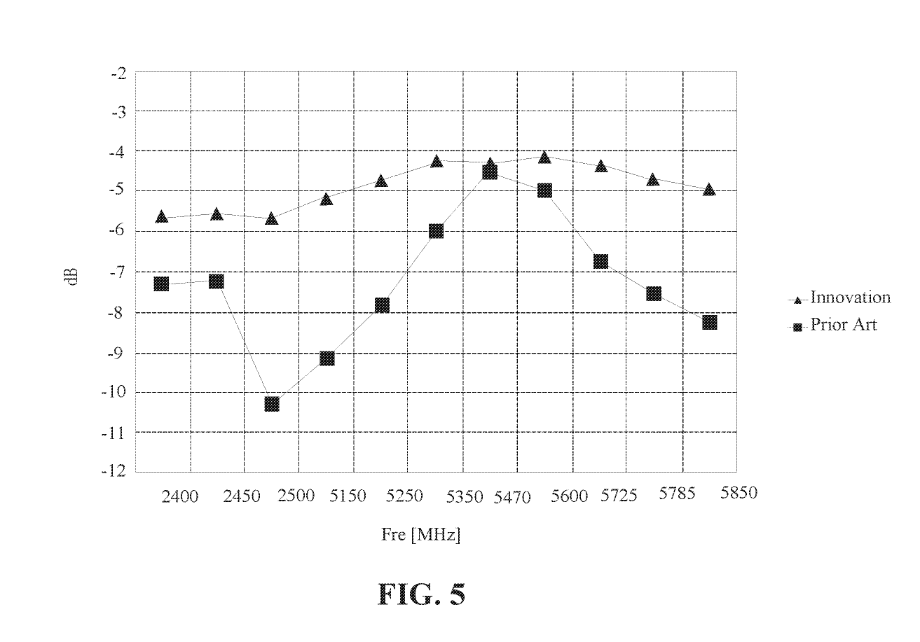

Further refer to FIGS. 4 and 5 showing VSWR and efficiency vs. frequency for the reverse-feeding antenna of the present invention, respectively. For comparison, FIGS. 4 and 5 also illustrate the performance of the traditional antenna. It is obvious that the present invention increases the bandwidth and efficiency particularly around a specific WIFI-operating frequency range, said 2400-2500 MHz and 5150-5850 MHz.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A reverse-feeding antenna for receiving and transmitting wireless signal, comprising:
an antenna body with an electrical conductor;
a coaxial cable comprising an inner conductor and an outer conductor; and
a grounding conductor,
wherein the inner conductor of the coaxial cable is electrically connected to the antenna body and the grounding conductor at a first connection point as an antenna feeding point, the outer conductor of the coaxial cable is electrically connected to the antenna body at a second connection point, and the grounding conductor is configured and electrically connected to both of the antenna body and surrounding conductor to form a ground part for the antenna body.

2. The reverse-feeding antenna as claimed in claim 1, wherein a metallic structure comprises at least one of a metallic enclosure, an LCD (liquid crystal display) panel and an electrical circuit board, the reverse-feeding antenna is installed onto the metallic structure and electrically connected to the metallic structure by the grounding conductor.

3. The reverse-feeding antenna as claimed in claim 2, wherein the metallic structure is a metal case for a wireless communication device.

4. The reverse-feeding antenna as claimed in claim 2, wherein the metallic structure is a metal case for a lap-top computer or all-in-one (AIO) host computer.

5. The reverse-feeding antenna as claimed in claim 1, wherein the electrical connection between both of the grounding conductor and the surrounding conductor comprises reactance elements to form a matching network so as to increase the flexibility and feasibility of impedance matching.

6. The reverse-feeding antenna as claimed in claim 5, wherein the reactance element comprises at least one capacitor, inductor or metal wire.
